(19) United States
(12) Patent Application Publication
(10) Pub. No.: US 2014/0178583 A1
(43) Pub. Date: Jun. 26, 2014

(54) Combinatorial Methods and Systems for Developing Thermochromic Materials and Devices

(71) Applicant: INTERMOLECULAR, INC., San Jose, CA (US)

(72) Inventors: Jeroen Van Duren, Palo Alto, CA (US); Sang Lee, San Jose, CA (US); Sandeep Nijhawan, Los Altos, CA (US)

(73) Assignee: INTERMOLECULAR, INC., San Jose, CA (US)

(21) Appl. No.: 13/721,472

(22) Filed: Dec. 20, 2012

(51) Int. Cl. B05D 5/00

(52) U.S. Cl. CPC B05D 5/00
USPC 427/248.1; 427/256

(57) ABSTRACT

Embodiments provided herein describe methods and systems for evaluating thermochromic material processing conditions. A plurality of site-isolated regions on at least one substrate are designated. A first thermochromic material is formed on a first of the plurality of site-isolated regions on the at least one substrate with a first set of processing conditions. A second thermochromic material is formed on a second of the plurality of site-isolated regions on the at least one substrate with a second set of processing conditions. The second set of processing conditions is different than the first set of processing conditions.

The present invention relates to thermochromic materials and devices. More particularly, this invention relates to methods and systems for developing thermochromic materials and devices in a combinatorial manner.

### BACKGROUND OF THE INVENTION

Combinatorial processing enables rapid evaluation of, for example, semiconductor and solar processing operations. The systems supporting the combinatorial processing are flexible to accommodate the demands for running the different processes either in parallel, serial or some combination of the two.

Some exemplary processing operations include operations for adding (depositions) and removing layers (etch), defining features, preparing layers (e.g., cleans), conversion of layers or surfaces, doping, etc. Similar processing techniques apply to the manufacture of integrated circuit (IC) semiconductor devices, flat panel displays, optoelectronics devices, data storage devices, magneto electronic devices, magneto optic devices, packaged devices, and the like. As manufacturing processes continue to increase in complexity, improvements, whether in materials, unit processes, or process sequences, are continually being sought for the multi-step processing sequence. However, semiconductor, thin-film-coating, and solar companies conduct research and development (R&D) on full wafer and (glass) substrate processing through the use of split lots, as the conventional deposition systems are designed to support this processing scheme. This approach has resulted in ever escalating R&D costs and the inability to conduct extensive experimentation in a timely and cost effective manner. Combinatorial processing as applied to semiconductor, solar, or energy-efficiency manufacturing operations enables multiple experiments to be performed at one time in a high throughput manner. Equipment for performing the combinatorial processing and characterization must support the efficiency offered through the combinatorial processing operations. The debottlenecking of the R&D efforts involves the above fast processing platforms in combination with throughput-matched characterization and fast automated data capture and analysis, in addition to accelerated lifetime testing and product simulations to allow a fast guidance for subsequent design of experiments to unravel the correlations between materials, processing, equipment, and product performance and durability.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale.

The techniques of the present invention can readily be understood by considering the following detailed description in conjunction with the accompanying drawings, in which:

FIG. 1 illustrates a schematic diagram for implementing combinatorial processing and evaluation using primary, secondary, and tertiary screening.

FIG. 2 is a simplified schematic diagram illustrating a general methodology for combinatorial process sequence integration that includes site isolated processing and/or conventional processing in accordance with some embodiments of the present invention.

FIG. 3 is a simplified schematic diagram illustrating an integrated high productivity combinatorial (HPC) system in accordance with some embodiments of the present invention.

FIG. 4 is a simplified schematic diagram illustrating a sputter processing chamber configured to perform combinatorial processing and full substrate processing in accordance with some embodiments of the present invention.

FIG. 5 is a simplified schematic diagram illustrating a sputter processing gun configured to perform combinatorial processing and full substrate processing in accordance with some embodiments of the present invention.

FIG. 6 is a simplified schematic diagram illustrating a wet processing tool configured to perform combinatorial processing in accordance with some embodiments of the present invention.

FIG. 7 is a simplified schematic diagram illustrating a thermochromic device in accordance with some embodiments of the present invention.

### DETAILED DESCRIPTION

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

Thermochromic materials, in general, are those that change color due to a change in temperature. Exemplary thermochromic materials include strontium calcium manganese oxide, neodymium nickel oxide, thermochromic tungsten, and fluorine-doped vanadium dioxide, which may be deposited using, for example, physical vapor deposition (PVD) or atomic layer deposition (ALD).

One important factor for the performance of thermochromic coatings is the metal-insulator transition which is dependent on stoichiometry and nanoscale morphology. When the thermochromic materials are to be used in window panels, ideally this transition is tuned to a temperature similar to typical outdoor temperatures. The impact of substrate conditions, deposition and additional processing conditions, and film majority and minority constituents composition on performance, cost, and durability are complex. By incorporating combinatorial processing, research and development of the transition, and thermochromic materials and coatings in general, may be accelerated.

Embodiments described herein provide methods and systems for developing and evaluating thermochromic materials and thermochromic material processing conditions. In some embodiments, a plurality of regions (e.g., site-isolated regions) are designated on at least one substrate (e.g., a glass substrate). A first thermochromic material is formed on a first of the plurality of regions on the at least one substrate with a first set of processing conditions. A second thermochromic material is formed on a second of the plurality of regions on the at least one substrate with a second set of processing conditions. The second set of processing conditions is different than the first set of processing conditions. However, it should be understood, that in some embodiments, the use of the same set of processing conditions may be repeated on several of the regions (or one or more substrate) to test for consistency and repeatability.

The first thermochromic material and the second thermochromic material may then be characterized. One of the first set of processing conditions and the second set of processing conditions may be selected based on the characterizing of the first thermochromic material and the second thermochromic material.

As such, in accordance with some embodiments, combinatorial processing may be used to produce and evaluate different materials, substrates, chemicals, consumables, processes, coating stacks, and techniques related to thermochromic materials, barrier layers, nucleation layers, and adhesion layers, as well as build structures or determine how thermochromic materials coat, fill or interact with existing structures in order to vary materials, unit processes and/or process sequences across multiple site-isolated regions on the substrate(s). These variations may relate to specifications such as temperatures, exposure times, layer thicknesses, chemical compositions of majority and minority elements of layers, gas compositions, chemical compositions of wet and dry surface chemistries, power and pressure of sputter deposition conditions, humidity, etc. of the formulations and/or the substrates at various stages of the screening processes described herein. However, it should be noted that in some embodiments, the chemical composition (e.g., of the thermochromic material and/or of the other components) remains the same, while other parameters are varied, and in other embodiments, the chemical composition is varied.

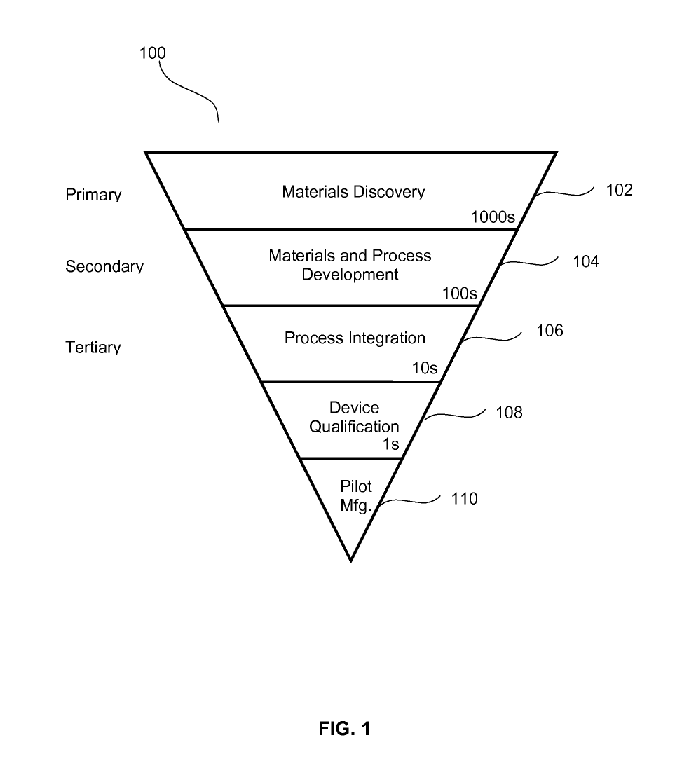

FIG. 1 illustrates a schematic diagram, 100, for implementing combinatorial processing and evaluation using primary, secondary, and tertiary screening. The schematic diagram, 100, illustrates that the relative number of combinatorial processes run with a group of substrates decreases as certain materials and/or processes are selected. Generally, combinatorial processing includes performing a large number of processes during a primary screen, selecting promising candidates from those processes, performing the selected processing during a secondary screen, selecting promising candidates from the secondary screen for a tertiary screen, and so on. In addition, feedback from later stages to earlier stages can be used to refine the success criteria and provide better screening results.

Although not shown, an initial stage may be implemented which includes a fast screening/search of structure-material property relationships, known process-material relationships, known stack-product (device) relationships, etc. within any available literature prior to starting any experimentation that results in materials discovery. After this initial stage, for example, thousands of materials are evaluated during a materials discovery stage, 102. Materials discovery stage, 102, is also known as a primary screening stage performed using primary screening techniques. Primary screening techniques may include dividing substrates into coupons and depositing materials using varied processes. The materials are then evaluated, and promising candidates are advanced to the secondary screen, or materials and process development stage, 104. Evaluation of the materials is performed using metrology tools such as ellipsometers, XRF, stylus profilers, hall measurements, optical transmission, reflection, and absorption testers, electronic testers and imaging tools (i.e., microscopes).

The materials and process development stage, 104, may evaluate hundreds of materials (i.e., a magnitude smaller than the primary stage) and may focus on the processes used to deposit or develop those materials. Promising materials and processes are again selected, and advanced to the tertiary screen or process integration stage, 106, where tens of materials and/or processes and combinations are evaluated. The tertiary screen or process integration stage, 106, may focus on integrating the selected processes and materials with other processes and materials.

The most promising materials and processes from the tertiary screen are advanced to device qualification, 108. In device qualification, the materials and processes selected are evaluated for high volume manufacturing, which normally is conducted on full substrates within production tools, but need not be conducted in such a manner. The results are evaluated to determine the efficacy of the selected materials and processes. If successful, the use of the screened materials and processes can proceed to pilot manufacturing, 110.

The schematic diagram, 100, is an example of various techniques that may be used to evaluate and select materials and processes for the development of new materials and processes. The descriptions of primary, secondary, etc. screening and the various stages, 102-110, are arbitrary and the stages may overlap, occur out of sequence, be described and be performed in many other ways. Additionally, it should be understood that the complexity of the samples/materials, as well as the evaluation thereof, may increase at each stage (e.g., the second stage may be more complex than the first, etc.).

This application benefits from High Productivity Combinatorial (HPC) techniques described in U.S. patent application Ser. No. 11/674,137 filed on Feb. 12, 2007 which is hereby incorporated for reference in its entirety. Portions of the '137 application have been reproduced below to enhance the understanding of the present invention. The embodiments described herein enable the application of combinatorial techniques to process sequence integration in order to arrive at a globally optimal sequence of thermochromic devices, semiconductor devices, TFPV modules, optoelectronic devices, etc. manufacturing operations by considering interaction effects between the unit manufacturing operations, the process conditions used to effect such unit manufacturing operations, hardware details used during the processing, as well as materials characteristics of components utilized within the unit manufacturing operations. Rather than only considering a series of local optimums, i.e., where the best conditions and materials for each manufacturing unit operation is considered in isolation, the embodiments described below consider interactions effects introduced due to the multitude of processing operations that are performed and the order in which such multitude of processing operations are performed when fabricating thermochromic devices, semiconductor devices, TFPV modules, optoelectronic devices, etc. A global optimum sequence order is therefore derived and as part of this derivation, the unit processes, unit process parameters and materials used in the unit process operations of the optimum sequence order are also considered.

The embodiments described further analyze a portion or sub-set of the overall process sequence used to manufacture thermochromic devices, semiconductor devices, TFPV modules, optoelectronic devices, etc. Once the subset of the process sequence is identified for analysis, combinatorial process sequence integration testing is performed to optimize the materials, unit processes, hardware details, and process sequence used to build that portion of the device or structure. During the processing of some embodiments described herein, structures are formed on the processed substrate that are equivalent to the structures formed during actual production of the thermochromic devices, semiconductor devices, TFPV modules, optoelectronic devices, etc. For example, such structures may include, but would not be limited to, contact layers, buffer layers, absorber layers, or any other series of layers or unit processes that create an intermediate structure found on thermochromic devices, semiconductor devices, TFPV modules, optoelectronic devices, etc. While the combinatorial processing varies certain materials, unit processes, hardware details, or process sequences, the composition or thickness of the layers or structures or the action of the unit process, such as cleaning, surface preparation, deposition, surface treatment, etc. is substantially uniform through each discrete region. Furthermore, while different materials or unit processes may be used for corresponding layers or steps in the formation of a structure in different designated regions of the substrate during the combinatorial processing, the application of each layer or use of a given unit process is substantially consistent or uniform throughout the different regions in which it is intentionally applied. Thus, the processing is uniform within a region (inter-region uniformity) and between regions (intra-region uniformity), as desired. It should be noted that the process can be varied between regions, for example, where a thickness of a layer is varied or a material may be varied between the regions, etc., as desired by the design of the experiment.

The result is a series of regions on the substrate that contain structures or unit process sequences that have been uniformly applied within that region and, as applicable, across different regions. This process uniformity allows comparison of the properties within and across the different regions such that the variations in test results are due to the varied parameter (e.g., materials, unit processes, unit process parameters, hardware details, or process sequences) and not the lack of process uniformity. In the embodiments described herein, the positions of the discrete (or site-isolated) regions on the substrate can be defined as needed, but are preferably systematized for ease of tooling and design of experimentation. In addition, the number, variants and location of structures within each region are designed to enable valid statistical analysis of the test results within each region and across regions to be performed.

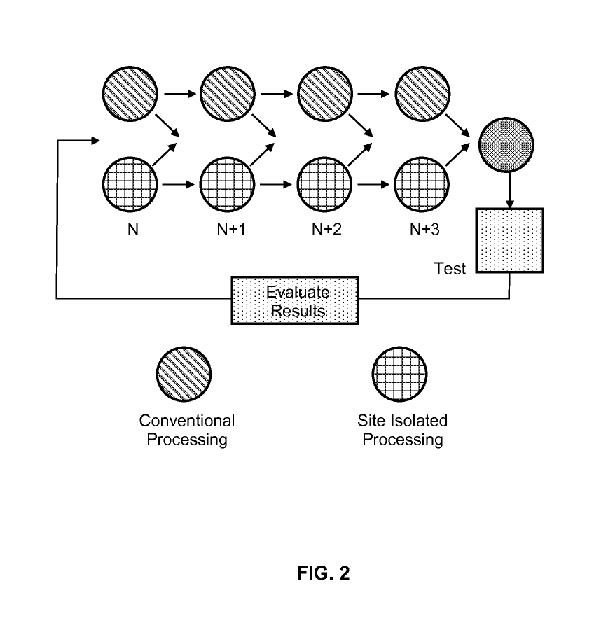

FIG. 2 is a simplified schematic diagram illustrating a general methodology for combinatorial process sequence integration that includes site isolated processing and/or conventional processing in accordance with some embodiments of the invention. In some embodiments, the substrate is initially processed using conventional process N. In some exemplary embodiments, the substrate is then processed using site isolated process N+1. During site isolated processing, an HPC module may be used, such as the HPC module described in U.S. patent application Ser. No. 11/352,077 filed on Feb. 10, 2006. The substrate can then be processed using site isolated process N+2, and thereafter processed using conventional process N+3. Testing is performed and the results are evaluated. The testing can include physical, chemical, acoustic, magnetic, electrical, optical, etc. tests. From this evaluation, a particular process from the various site isolated processes (e.g. from steps N+1 and N+2) may be selected and fixed so that additional combinatorial process sequence integration may be performed using site isolated processing for either process N or N+3. For example, a next process sequence can include processing the substrate using site isolated process N, conventional processing for processes N+1, N+2, and N+3, with testing performed thereafter.

It should be appreciated that various other combinations of conventional and combinatorial processes can be included in the processing sequence with regard to FIG. 2. That is, the combinatorial process sequence integration can be applied to any desired segments and/or portions of an overall process flow. Characterization, including physical, chemical, acoustic, magnetic, electrical, optical, etc. testing, can be performed after each process operation, and/or series of process operations within the process flow as desired. The feedback provided by the testing is used to select certain materials, processes, process conditions, and process sequences and eliminate others. Furthermore, the above flows can be applied to entire monolithic substrates, or portions of monolithic substrates such as coupons.

Under combinatorial processing operations the processing conditions at different regions can be controlled independently. Consequently, process material amounts, reactant species, processing temperatures, processing times, processing pressures, processing flow rates, processing powers, processing reagent compositions, the rates at which the reactions are quenched, deposition order of process materials, process sequence steps, hardware details, etc., can be varied from region to region on the substrate. Thus, for example, when exploring materials, a processing material delivered to a first and second region can be the same or different. If the processing material delivered to the first region is the same as the processing material delivered to the second region, this processing material can be offered to the first and second regions on the substrate at different concentrations. In addition, the material can be deposited under different processing parameters. Parameters which can be varied include, but are not limited to, process material amounts, reactant species, processing temperatures, processing times, processing pressures, processing flow rates, processing powers, processing reagent compositions, the rates at which the reactions are quenched, atmospheres in which the processes are conducted, an order in which materials are deposited, hardware details of the gas distribution assembly, etc. It should be appreciated that these process parameters are exemplary and not meant to be an exhaustive list as other process parameters commonly used in semiconductor device, TFPV module, optoelectronic device, etc. manufacturing may be varied.

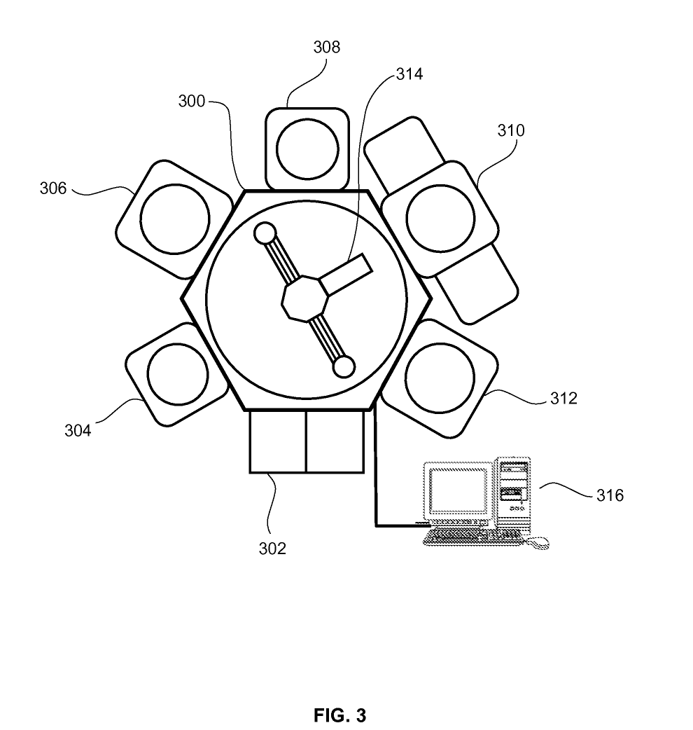

FIG. 3 is a simplified schematic diagram illustrating an integrated high productivity combinatorial (HPC) system in accordance with some embodiments of the invention. HPC system includes a frame 300 supporting a plurality of processing modules. It should be appreciated that frame 300 may be a unitary frame in accordance with some embodiments. In some embodiments, the environment within frame 300 is controlled. Load lock/factory interface 302 provides access into the plurality of modules of the HPC system. Robot 314 provides for the movement of substrates (and masks) between the modules and for the movement into and out of the load lock 302. Modules (or processing tools) 304-312 may be any set of modules and preferably include one or more combinatorial modules. For example, module 304 may be an orientation/degassing module, module 306 may be a clean module, either plasma or non-plasma based, modules 308 and/or 310 may be combinatorial/conventional dual purpose modules. Module 312 may provide conventional clean or degas as necessary for the experiment design.

Any type of chamber or combination of chambers may be implemented and the description herein is merely illustrative of one possible combination and not meant to limit the potential chamber or processes that can be supported to combine combinatorial processing or combinatorial plus conventional processing of a substrate or wafer. In some embodiments, a centralized controller, i.e., computing device 316, may control the processes of the HPC system, including the power supplies and synchronization of the duty cycles described in more detail below. Further details of one possible HPC system are described in U.S. application Ser. No. 11/672,478 filed Feb. 7, 2007, now U.S. Pat. No. 7,867,904 and claiming priority to U.S. Provisional Application No. 60/832,248 filed on Jul. 19, 2006, and U.S. application Ser. No. 11/672,473, filed Feb. 7, 2007, and claiming priority to U.S. Provisional Application No. 60/832,248 filed on Jul. 19, 2006, which are all herein incorporated by reference. With HPC system, a plurality of methods may be employed to deposit material upon a substrate employing combinatorial processes.

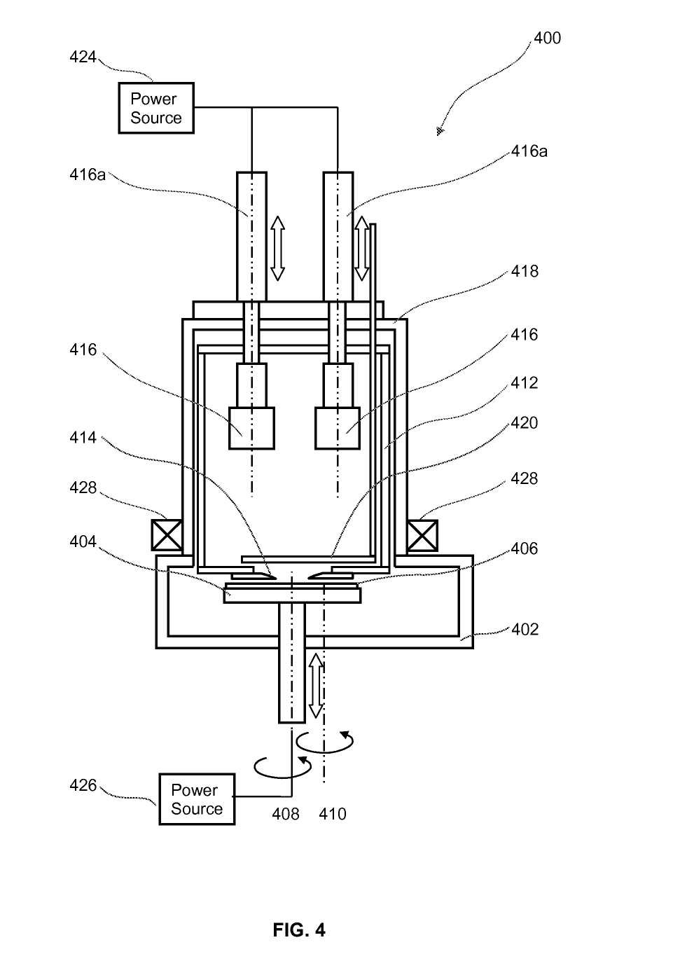

FIG. 4 is a simplified schematic diagram illustrating a PVD chamber (or processing tool), more particularly, a sputter chamber, configured to perform combinatorial processing and full substrate processing in accordance with some embodiments of the invention. Processing chamber 400 includes a bottom chamber portion 402 disposed under top chamber portion 418. Within bottom portion 402, substrate support 404 is configured to hold a substrate 406 disposed thereon and can be any known substrate support, including but not limited to a vacuum chuck, electrostatic chuck or other known mechanisms. Substrate support 404 is capable of both rotating around its own central axis 408 (referred to as “rotation” axis), and rotating around an exterior axis 410 (referred to as “revolution” axis). Such dual rotary substrate support is central to combinatorial processing using site-isolated mechanisms. Other substrate supports, such as an XY table, can also be used for site-isolated deposition. In addition, substrate support 404 may move in a vertical direction. It should be appreciated that the rotation and movement in the vertical direction may be achieved through known drive mechanisms which include magnetic drives, linear drives, worm screws, lead screws, a differentially pumped rotary feed through drive, etc. Power source 426 provides a bias power to substrate support 404 and substrate 406 and produces a negative bias voltage on substrate 406. In some embodiments power source 426 provides a radio frequency (RF) power sufficient to take advantage of the high metal ionization to improve step coverage of vias and trenches of patterned wafers. In some embodiments, the RF power supplied by power source 426 is pulsed and synchronized with the pulsed power from power source 424.

Substrate 406 may be a conventional round 200 mm, 300 mm, or any other larger or smaller substrate/wafer size. In some embodiments, substrate 406 may be a square, rectangular, or other shaped substrate. In some embodiments, substrate 406 is made of glass. However, in other embodiments, the substrate 406 is made of a semiconductor material, such as silicon. One skilled in the art will appreciate that substrate 406 may be a blanket substrate, a coupon (e.g., partial wafer), or even a patterned substrate having predefined regions. In some embodiments, substrate 406 may have regions defined through the processing described herein. The term region is used herein to refer to a localized (or site-isolated) area on a substrate which is, was, or is intended to be used for processing or formation of a selected material. The region can include one region and/or a series of regular or periodic regions predefined on the substrate. The region may have any convenient shape, e.g., circular, rectangular, elliptical, wedge-shaped, etc. In the semiconductor field, a region may be, for example, a test structure, single die, multiple dies, portion of a die, other defined portion of substrate, or an undefined area of a substrate, e.g., blanket substrate which is defined through the processing.

Top chamber portion 418 of chamber, 400, in FIG. 4 includes process kit shield 412, which defines a confinement region over a radial portion of substrate 406. Process kit shield 412 is a sleeve having a base (optionally integrated with the shield) and an optional top within chamber 400 that may be used to confine a plasma generated therein. The generated plasma will dislodge atoms from a target and the sputtered atoms will deposit on an exposed surface of substrate 406 to combinatorial process regions of the substrate in a site-isolated manner (e.g., such that only the particular region on the substrate is processed) in some embodiments. In other embodiments, full wafer processing can be achieved by optimizing gun tilt angle and target-to-substrate spacing, and by using multiple process guns 416. Process kit shield 412 is capable of being moved in and out of chamber 400 (i.e., the process kit shield is a replaceable insert). In other embodiments, process kit shield 412 remains in the chamber for both the full substrate and combinatorial processing. Process kit shield 412 includes an optional top portion, sidewalls and a base. In some embodiments, process kit shield 412 is configured in a cylindrical shape, however, the process kit shield may be any suitable shape and is not limited to a cylindrical shape.

The base of process kit shield 412 includes an aperture 414 through which a surface of substrate 406 is exposed for deposition or some other suitable semiconductor processing operations. Aperture shutter 420 which is moveably disposed over the base of process kit shield 412. Aperture shutter 420 may slide across a bottom surface of the base of process kit shield 412 in order to cover or expose aperture, 414, in some embodiments. In other embodiments, aperture shutter 420 is controlled through an arm extension which moves the aperture shutter to expose or cover aperture 414. It should be noted that although a single aperture is illustrated, multiple apertures may be included. Each aperture may be associated with a dedicated aperture shutter or an aperture shutter can be configured to cover more than one aperture simultaneously or separately. Alternatively, aperture 414 may be a larger opening and aperture shutter 420 may extend with that opening to either completely cover the aperture or place one or more fixed apertures within that opening for processing the defined regions. The dual rotary substrate support 404 is central to the site-isolated mechanism, and allows any location of the substrate or wafer to be placed under the aperture 414. Hence, the site-isolated deposition is possible at any location on the wafer/substrate.

In the example shown in FIG. 4, two process guns 416 are included. Process guns 416 are moveable in a vertical direction so that one or both of the guns may be lifted from the slots of the shield. While two process guns are illustrated, any number of process guns may be included, e.g., one, three, four or more process guns may be included. Where more than one process gun is included, the plurality of process guns may be referred to as a cluster of process guns. In some embodiments, process guns 416 are oriented or angled so that a normal reference line extending from a planar surface of the target of the process gun is directed toward an outer periphery of the substrate in order to achieve good uniformity for full substrate deposition film. The target/gun tilt angle depends on the target size, target-to-substrate spacing, target material, process power/pressure, etc.

Top chamber portion 418 of chamber 400 of FIG. 4 includes sidewalls and a top plate which house process kit shield 412. Arm extensions 416a which are fixed to process guns 416 may be attached to a suitable drive, (i.e., lead screw, worm gear, etc.), configured to vertically move process guns 416 toward or away from a top plate of top chamber portion 418. Arm extensions 416a may be pivotally affixed to process guns 416 to enable the process guns to tilt relative to a vertical axis. In some embodiments, process guns 416 tilt toward aperture 414 when performing combinatorial processing and tilt toward a periphery of the substrate being processed when performing full substrate processing. It should be appreciated that process guns 416 may tilt away from aperture 414 when performing combinatorial processing in other embodiments. In yet other embodiments, arm extensions 416a are attached to a bellows that allows for the vertical movement and tilting of process guns 416. Arm extensions 416a enable movement with four degrees of freedom in some embodiments. Where process kit shield 412 is utilized, the aperture openings are configured to accommodate the tilting of the process guns. The amount of tilting of the process guns may be dependent on the process being performed in some embodiments.

Power source 424 provides power for sputter guns 416 whereas power source 426 provides RF bias power to an electrostatic chuck. As mentioned above, the output of power source 426 is synchronized with the output of power source 424. It should be appreciated that power source 424 may output a direct current (DC) power supply or a radio frequency (RF) power supply. In other embodiments, the DC power is pulsed and the duty cycle is less than 30% on-time at maximum power in order to achieve a peak power of 10-15 kilowatts. Thus, the peak power for high metal ionization and high density plasma is achieved at a relatively low average power which will not cause any target overheating/cracking issues. It should be appreciated that the duty cycle and peak power levels are exemplary and not meant to be limiting as other ranges are possible and may be dependent on the material and/or process being performed.

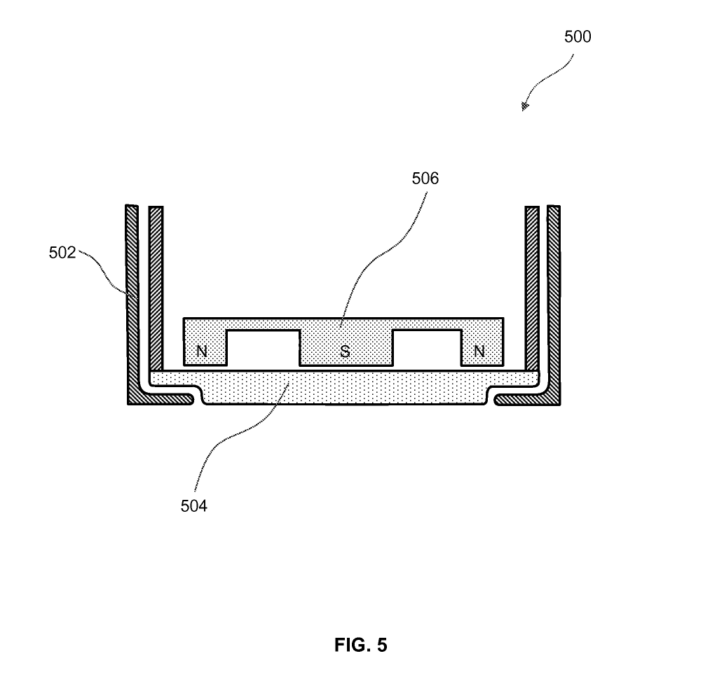

FIG. 5 is a simplified schematic diagram illustrating a sputter processing chamber configured to perform combinatorial processing and full substrate processing before implementation of some embodiments of the present invention. FIG. 5 illustrates a portion of a sputter gun 500 that would be part of the sputter gun 416 in FIG. 4. Illustrated in FIG. 5 is a grounded shield, 502 surrounding the exterior of the target 504 and magnetron 506 assembly.

Using processing chamber 400, perhaps in combination with other processing tools, thermochromic materials may be developed and evaluated in the manner described above. In particular, in some embodiments, thermochromic materials may be formed on different site-isolated regions of substrate 406 (or on multiple substrates) under varying processing conditions (including the formation/deposition of different thermochromic material). For example, thermochromic material may be ejected from one of more of targets 504 and deposited onto a first of the regions on substrate 406 under a first set of processing conditions, and either sequentially or simultaneously, thermochromic material may be ejected from one of more of targets 504 and deposited onto a second of the regions on substrate 406 under a different, second set of processing conditions. The thermochromic material(s) (and/or thermochromic material processing conditions) may then be characterized. Particular materials and/or processing conditions may then be selected (e.g., for further testing or use in devices) based on the desired parameters.

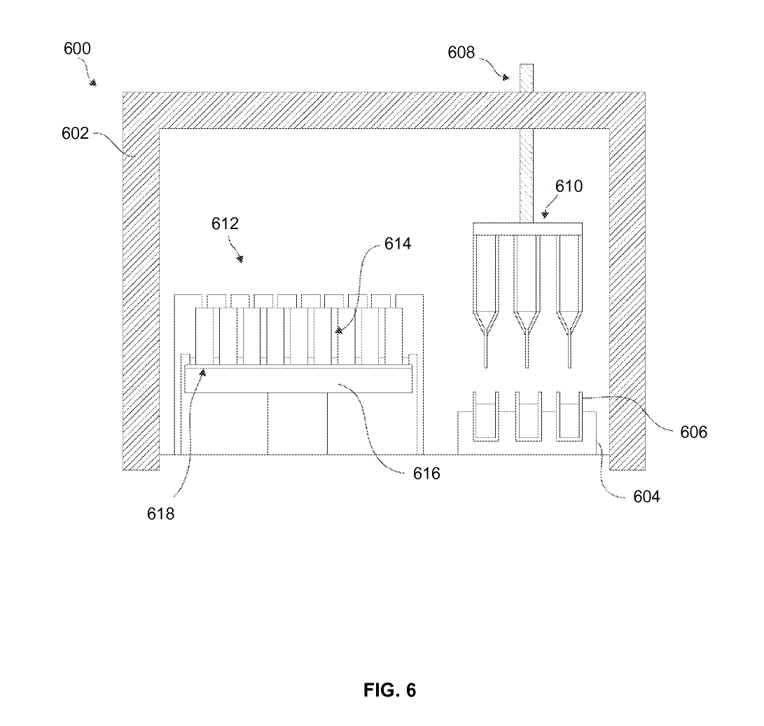

It should be understood that the development of the thermochromic materials may involve the use of multiple processing tools, such as modules 304-312 in FIG. 3. For example, various other materials/layers (e.g., as shown in FIG. 6), in addition to the thermochromic material, may be formed on each site-isolated region on the substrate, and additional processing steps, such as cleanings, may be performed at various stages of the processing, in processing tools/chambers different from the one in which the thermochromic material(s) are formed. This processing may utilize several of the modules 304-312 and involve transporting the substrate between the modules in a controlled environment (e.g., without breaking vacuum).

FIG. 6 is a simplified view of a combinatorial wet processing tool 600, according to some embodiments of the present invention. Similarly to the chamber 400 shown in FIG. 4, wet processing tool 600 may be used to perform combinatorial processing on multiple site-isolated regions on a substrate using, in this case, wet processing techniques.

The combinatorial wet processing tool 600 includes a housing (and/or processing chamber) 602, a well holder 604 holding wells 606, and a dispense arm 608 having a dispense head 610. The wet processing tool 600 also includes a reactor assembly 612 having an array or reactors (or fluid containers) 614 positioned over a substrate support 616. A substrate 618 is placed on the substrate support 616 and positioned relative to the reactors 614 such that bottom edges of the reactors contact the substrate 618 and form seals around respective, site-isolated portions of the substrate 618. The dispense arm 610 may retrieve (e.g., via syringes) formulations (e.g., thermochromic materials) from the wells 606 and dispense them into the reactors 614. Because of the seals formed between the reactors 614 and the substrate 618, the formulations remain within the reactors 614 and on the respective regions of the substrate 618, and are thus isolated from the other formulations and regions on the substrate 618. The formulations may be varied by varying, for example, the chemical composition or exposure time.

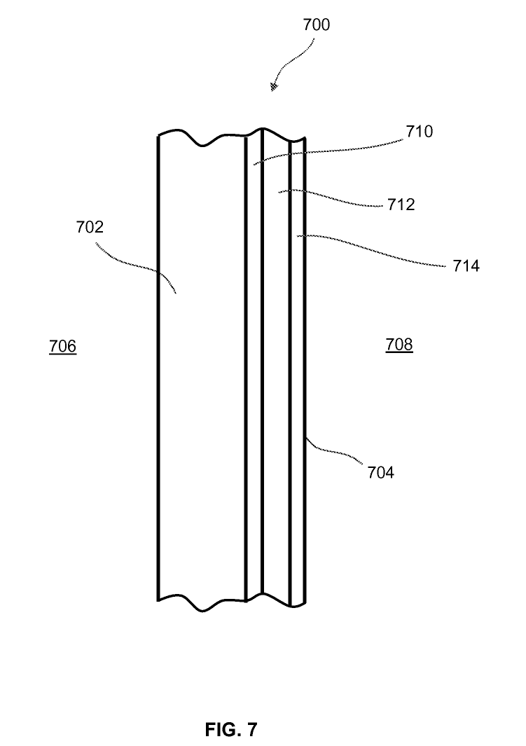

FIG. 7 illustrates an exemplary thermochromic device 700, according to some embodiments. The device 700 includes a substrate (e.g., a glass substrate) 702 and thermochromic coating 704 formed on one side of substrate 702. Device 700 may be understood to have a first (or interior) side 706 and a second (or exterior) side 708. As shown, thermochromic coating 704 is on a side of substrate 702 adjacent to second side 708 of device 700.

In the example shown, the thermochromic coating 704 includes a first barrier layer 710, a thermochromic layer 712, and a second barrier layer 714. Such a thermochromic coating 704 may be formed by, for example, first performing a wet cleaning on the surface of the substrate 702 and sequentially forming the first barrier layer 710, the thermochromic material 712, and the second barrier layer 714 using, for example, sputter deposition. The first barrier layer may be made of, for example, silicon oxide. The second barrier layer may be made of, for example, silicon nitride. After the second barrier layer 714 is formed, the device 700 may undergo an annealing process performed in an environment of, for example, nitrogen, argon, or air. Additionally, although not shown, in some embodiments, a nucleation layer may be formed on the first barrier layer 710, and an adhesion layer may be included between the thermochromic material 712 and the second barrier layer 714. However, in other embodiments, even fewer layers may be used.

Furthermore, it should be understood that the thermochromic device 700 may be a portion of a larger, more complex device or system, such as a thermochromic window. Such a thermochromic window may include multiple glass substrates (or panes) and other coatings (or layers). For example, a low emissivity (“low-e”) coating (e.g., utilizing a silver layer) may be formed on another pane of the window, and various barrier or spacer layers may be formed between adjacent panes.

After being installed and in use, when the temperature of thermochromic coating 704 is below the transition temperature of the particular thermochromic material used, electromagnetic radiation (e.g., solar radiation) passes from second side 708 to first side 706 through both thermochromic coating 704 and substrate 706. However, when the temperature of the thermochromic coating 704 reaches the transition temperature of the particular thermochromic material, the material undergoes a semiconductor-to-metal transition causing the color, reflectance, and transmittance of thermochromic coating 704, and thus the entire device 700, to change. After the transition, only a reduced amount of electromagnetic radiation passes from second side 708 to first side 706 of device 700, while the remainder is reflected. When particular thermochromic materials are used, when the temperature of the thermochromic coating drops below the transition temperature, the transition will be reversed such that the original amount solar radiation will pass through device 700.

Thus, in some embodiments, methods for evaluating thermochromic material processing conditions are provided, the methods comprising. A plurality of site-isolated regions on at least one substrate are designated. A first thermochromic material is formed on a first of the plurality of regions on the at least one substrate with a first set of processing conditions. A second thermochromic material is formed on a second of the plurality of regions on the at least one substrate with a second set of processing conditions. The second set of processing conditions is different than the first set of processing conditions.

In some embodiments, methods for evaluating thermochromic material processing conditions are provided, the methods comprising. A substrate, having a plurality of site-isolated regions thereon, is positioned in a processing chamber. A first thermochromic material is formed on a first of the plurality of regions on the substrate with a first set of processing conditions. A second thermochromic material is formed on a second of the plurality of regions on the substrate with a second set of processing conditions. The second set of processing conditions is different than the first set of processing conditions.

In some embodiments, methods for evaluating thermochromic material processing conditions are provided. A substrate, having a plurality of site-isolated regions thereon, is positioned in a processing chamber having at least one target comprising a thermoelectric material positioned therein. The thermoelectric material is caused to be ejected from the at least one target under a first set of processing conditions such that the thermoelectric material is deposited on a first of the plurality of regions on the substrate. The thermoelectric material is caused to be ejected from the at least one target under a second set of processing conditions such that the thermoelectric material is deposited on a second of the plurality of regions on the substrate. The second set of processing conditions is different than the first set of processing conditions

Although the foregoing examples have been described in some detail for purposes of clarity of understanding, the invention is not limited to the details provided. There are many alternative ways of implementing the invention. The disclosed examples are illustrative and not restrictive.

What is claimed:

1. A method for evaluating thermochromic material processing conditions, the method comprising:
providing a plurality of site-isolated regions on at least one substrate;
forming a first thermochromic material on a first of the plurality of site-isolated regions on the at least one substrate with a first set of processing conditions; and
forming a second thermochromic material on a second of the plurality of site-isolated regions on the at least one substrate with a second set of processing conditions,
wherein the second set of processing conditions is different than the first set of processing conditions.

2. The method of claim 1, further comprising:
characterizing the first thermochromic material and the second thermochromic material; and
selecting one of the first set of processing conditions or the second set of processing conditions based on the characterizing of the first thermochromic material and the second thermochromic material.

3. The method of claim 1, wherein the first of the plurality of site-isolated regions and the second of the plurality of site-isolated regions are on the same substrate.

4. The method of claim 3, wherein the first thermochromic material and the second thermochromic material are formed in the same processing chamber.

5. The method of claim 4, wherein the first thermochromic material and the second thermochromic material have different chemical compositions.

6. The method of claim 4, wherein the first thermochromic material and the second thermochromic material have the same chemical composition.

7. The method of claim 4, wherein the first thermochromic material and the second thermochromic material are formed using physical vapor deposition (PVD).

8. The method of claim 7, wherein the first and second thermochromic materials are ejected from first and second targets within the processing chamber.

9. The method of claim 1, wherein the first thermochromic material and the second thermochromic material are formed using atomic layer deposition (ALD).

10. The method of claim 1, wherein the first thermochromic material and the second thermochromic material comprise at least one of strontium calcium manganese oxide, neodymium nickel oxide, thermochromic tungsten, fluorine-doped vanadium dioxide, or a combination thereof.

11. A method for evaluating thermochromic material processing conditions, the method comprising:
positioning a substrate in a processing chamber, the substrate having a plurality of site-isolated regions thereon;
forming a first thermochromic material on a first of the plurality of site-isolated regions on the substrate with a first set of processing conditions; and
forming a second thermochromic material on a second of the plurality of site-isolated regions on the substrate with a second set of processing conditions,
wherein the second set of processing conditions is different than the first set of processing conditions.

12. The method of claim 11, wherein the forming of the first thermochromic material comprises causing the first thermochromic material to be ejected from at least one target within the processing chamber, and the forming of the second thermochromic material comprises causing the second thermochromic material to be ejected from the at least one target within the processing chamber.

13. The method of claim 12, further comprising
characterizing the first thermochromic material and the second thermochromic material; and
selecting one of the first set of processing conditions or the second set of processing conditions based on the characterizing of the first thermochromic material and the second thermochromic material.

14. The method of claim 11, wherein the first thermochromic material and the second thermochromic material are formed in a first processing chamber, and further comprising:
transporting the substrate to a second processing chamber; and
processing the first of the plurality of site-isolated regions on the substrate and the second of the plurality of site-isolated regions on the substrate in the second processing chamber.

15. The method of claim 11, wherein the first thermochromic material and the second thermochromic material comprise at least one of strontium calcium manganese oxide, neodymium nickel oxide, thermochromic tungsten, fluorine-doped vanadium dioxide, or a combination thereof.

16. A method for evaluating thermochromic material processing conditions, the method comprising:
positioning a substrate in a processing chamber having at least one target positioned therein, the at least one target comprising thermoelectric material, the substrate having a plurality of site-isolated regions thereon;
causing the thermoelectric material to be ejected from the at least one target under a first set of processing conditions such that the thermoelectric material is deposited on a first of the plurality of site-isolated regions on the substrate; and
causing the thermoelectric material to be ejected from the at least one target under a second set of processing conditions such that the thermoelectric material is deposited on a second of the plurality of site-isolated regions on the substrate;
wherein the second set of processing conditions is different than the first set of processing conditions.

17. The method of claim 16, further comprising:
characterizing the first thermochromic material and the second thermochromic material; and
selecting one of the first set of processing conditions or the second set of processing conditions based on the characterizing of the first thermochromic material and the second thermochromic material.

18. The method of claim 16, wherein the at least one target comprises a first target and a second target, wherein the first target has a different chemical composition than the second target.

19. The method of claim 16, wherein the thermochromic material comprises at least one of strontium calcium manganese oxide, neodymium nickel oxide, thermochromic tungsten, fluorine-doped vanadium dioxide, or a combination thereof.

20. The method of claim 16, wherein causing the thermoelectric material to be ejected from the at least one target under the second set of processing conditions occurs after causing the thermoelectric material to be ejected from the at least one target under the first set of processing conditions.
